(19) United States
(12) Patent Application Publication
(10) Pub. No.: US 2011/0111359 A1
(43) Pub. Date: May 12, 2011

(54) Dental extracted tooth replacement method

(76) Inventor: Arthur Kitchings Weathers, JR., Las Vegas, NV (US)

(21) Appl. No.: 12/590,438

(22) Filed: Nov. 9, 2009

(51) Int. Cl. A61C 8/00; A61C 13/225

(52) U.S. Cl. 433/29; 433/215; 433/175

(57) ABSTRACT

This application relates to the field of dentistry, and in more particular to the field of prosthetic dentistry. The application describes the same day insertion of a novel tooth socket dental implant following the atraumatic extraction of a tooth. The nonmetallic implant is manufactured of UHMWPE to be a biological copy or alias of the extracted tooth, and is suitable for later fitting of a prior-art porcelain cap to an abutment on the exposed end of the implant. The lower contact surface of the novel implant is pocked with shallow excavations to allow the living tissues inside the socket to expand into them as an enhanced means of natural adhesion. Alternately or together with the excavations, thin strips, strands, or mesh sections of titanium are vertically flush mounted along the contact surface to promote osseointegration.

### BACKGROUND OF THE INVENTION

This application relates to the field of dentistry, and in more particular to the field of prosthetic dentistry. The application describes the insertion of a novel implant in a patient's jaw following the atraumatic extraction of a tooth. The implant is suitable for later fitting of a prior art porcelain cap to an abutment on the exposed end of the implant. The contact surface of the novel implant is pocked with shallow excavations that collectively allow a large invasion of new bone growth culminating with a safe long term integration of the implant with the patient's jawbone.

### DESCRIPTION OF THE RELATED ART

Before the discovery of implant technology, the replacement of a missing tooth was typically done by a bridge or dentures. For the last three decades a titanium screw has been successfully inserted into the living bone of an upper or lower jaw, left there for up to six months to allow osseointegration, and later fitted with a “cap” or “crown” tailored to the individual patient. The value of titanium implants is especially high for teeth that have been missing for years, as the original socket of the lost tooth's socket are usually filled in with bone cells by the body's restorative abilities.

Keeping in mind the need for suitable anchoring medium, dental sites experiencing tooth extractions (that are intended for later repair) are not typically suitable for titanium implants until lengthy healing and bone restoration has occurred. This means if a titanium screw implant is ultimately intended for a site with a tooth in it, a quick extraction of the tooth with forceps may be employed, and the initial condition of the socket is less important. However, recently more sophisticated extraction procedures have been introduced that involves a series of steps requiring particular implements to remove teeth without cracking the living alveolar bone. Because such trauma is reduced or eliminated, these systems have become known as atraumatic procedures. The instant inventor, a dentist, has previously filed U.S. application Ser. No. 11/974,486 which has more background on this procedure.

The material of an implant must be “biocompatible,” a defining term that means a substance that when placed in living tissues does not bring about an immune response. Stainless steel and titanium are two examples of this substance. The art has produced many other metallurgical examples, such as was introduced by U.S. Pat. No. 4,187,608 in 1980. The defining limitation of this paper involves the use of powdered metallurgical particles that were later sintered. By design, the final implant had extremely tiny porous spaces left behind in the sintering process which were intended to promote attachment of living cells into these spaces. It is now speculation that the death of isolated living cells entering these porous spaces and later decaying caused a serious lack of biocompatibility. At any rate, the cited paper was a pioneer in the implant field.

Numerous attempts were made in the art over the next several decades with cloned implants to “coat” the various metallurgical surfaces with biocompatible material, such as is best shown in U.S. Pat. No. 5,478,237 where hydroxyapatite is employed. However, the time and cost to prepare coated individualized implants is appreciable. During the lengthy manufacturing process, the patient's socket undergoes size and capacity distortions, as in exterior scar formation, as the body responds to the trauma of losing the tooth. In the past, the dental industry has come to accept that the rejection ratio of cloned implants is unacceptably high. For these and other reasons, no cloned system has yet taken any significant market share over screw titanium implants.

Recently, Austrian patent AT502881, which is pending PCT/AT2006/000405, claims a non pure titanium implant that is mainly formed of Zirconia. As with all prior art cloned implants, the Zirconia implant is manufactured during the time a tooth socket begins the healing process subsequent to a tooth's extraction. As a novelty, the implant features protuberances termed “macro retentions” on the contacting surface. When the implant is ready, because the body has begun to fill in the socket with growth, the implant is tapped by a dental hammer into the semi-healed socket. The protuberances extend into the living tissues of the socket to initially secure the implant and, after subsequent months of healing, are further secured by additional growth. Lastly, a porcelain cap is secured to an abutment on the implant. Notably, there is still a considerable time for the patient to wait for the metallic Zirconia implant after the tooth is taken, the manufacturing cost is significant and will be passed along to the patient in most capitalist countries, and the placement involves high cellular trauma.

### BRIEF DESCRIPTION OF THE INVENTION AND ADVANTAGES

The instant invention, as does the cited art, involves the preparation of a novel cloned implant manufactured to the shape of an extracted tooth. “Cloned” means a morphological copy or alias with the dimensions of the original. The preferred instant implant is created with scalloped cavitations randomly placed over the contacting surface to maintain a content dimension less than that of the extracted tooth's root socket. These novel invaginated surface sites achieve the long desired natural fastening of the socket to the implant during a recovery process when:

1) The tooth is removed atraumatically.

2) The implant is created and inserted in the socket the same day it is extracted.

The biocompatible substance utilized for the instant implant is not metallic. It is known by the acronym UHMWPE, which stands for ultra high molecular weight polyethylene. This would include any other derivatives or enhanced chemical analogues developed by the chemical art. An example of a preferred derivative would be HC-UHMWPE, where “HC” is a further acronym for “highly cross-linked” UHMWPE. The latter is an immensely strong solid at body temperature that has been used in hip replacement procedures. A feature of HC-UHMWPE is that it can be congealed at relatively low temperatures and cured to a final shape very rapidly. (More information about UHMWPE is found in “The UHMWPE Handbook” by S. M Kurtz, ISBN number 0-12-429851-6, Academic Press Boston, Ma. See especially Chapter 11 for congruous material.)

It is therefore accordingly an object of the present invention to detail the steps of a dental procedure whereby an extracted tooth is replaced with an uncapped implant featuring the exact contacting shape of the extracted tooth without a forceful insertion.

It is also accordingly an object of the present invention to detail the steps of a dental procedure whereby an extracted tooth is replaced with an uncapped implant within hours rather than weeks or months.

It is also accordingly an object of the present invention to detail the steps of a dental procedure whereby an extracted tooth is replaced with an uncapped implant featuring scalloped cavitations randomly placed over the contacting surface of the implant. These cavitations, each as a whole, have a smooth surface rather than porous or jagged pockets, whereby all new cellular growth is accessible to the body's cleansing abilities for removal of any dead cell components that later arise. The scalloped cavitations allow the body's living germative bony tissues to extend congruous cellular mass into the capacity of the implant for permanent adherence.

It is also accordingly an object of the present invention to detail the steps of a dental procedure whereby an extracted tooth is replaced with an uncapped implant manufactured from a tremendously strong material that is biocompatible in the property of not being subject to rejection by the antibodies of the patient's immune system.

It is also accordingly an object of the present invention to detail the steps of a dental procedure whereby an extracted tooth is replaced with an uncapped implant entirely under the supervision of one dentist, or the in-house associates of that one dentist, whereby quality of control is not left to outside or second party influences.

It is also accordingly an object of the present invention to detail the steps of a dental procedure whereby an extracted tooth is replaced with an uncapped implant that will heal and bind faster to the patient's upper or lower jawbone than competing systems stressing the delicate tissues of a partially healed tooth socket.

It is also accordingly an object of the present invention to detail the steps of a dental procedure whereby an extracted tooth is replaced with an uncapped implant that will cost much less to the patient in economic terms than the cost of prior art implants.

It is also accordingly an object of the present invention to detail the steps of a dental procedure whereby an extracted tooth is replaced with an uncapped implant that can later be fitted with a traditional permanent cap with less patient recovery time.

### BRIEF DESCRIPTION OF THE DRAWINGS

FIG. 1 is a perspective view of an extracted tooth that has been sheared of its original crown, and an abutment with a flat lower surface.

FIG. 2 is a perspective view of the objects of FIG. 1 after the abutment has been adhered to the tooth with fast-drying glue and the tooth's surface has been randomly covered with about a dozen scalloped cavitations.

FIG. 3 is a perspective view of the objects of FIG. 2 after the junction of the abutment and the tooth has been joined by a circumferential band of modeling clay or dental wax.

FIG. 4 is a side cutaway view of the objects of FIG. 3 after insertion into a filled cup of uncongealed transparent mold rubber to make a mold pattern of the prepared tooth and abutment.

FIG. 5 is a side view of the finished mold of FIG. 4 being filled with finely granulated UHMWPE.

FIG. 6 is a side view of the finished mold of FIG. 4 being filled with finely granulated UHMWPE, but unlike FIG. 5 also has a rod of stainless steel inserted down into the mold with a grasping section left un-inserted. Small strips of titanium line the inner mold surface. The rod and strips depict alternate methodology to that of FIG. 5.

FIG. 7 is a side view of the finished mold of FIG. 6 after it is completely filled with finely granulated UHMWPE. The mold has been placed inside an irradiation box with one or a plurality of electron beam emitters to subsequently generate a cloned implant by a gentle exothermic reaction. The granulated UHMWPE is melted and fused by cross-linking of the molecules within seconds by the radiation.

FIG. 8 is a frontal view of a patient's lower jaw where the socket of the tooth shown in FIG. 1 was extracted. The cloned implant, because it does not exceed the dimensions of the original tooth's root, can be smoothly pushed into the socket.

FIG. 9 is a frontal view of FIG. 8 after a temporary bridge of dental orthodontic wire is adhered to the cloned implant and two adjacent teeth. This wire holds the implant in position to allow integration of the implant with the jaw's living tissues as the socket begins recovery from the atraumatic removal process of the original tooth.

### DETAILED DESCRIPTION OF THE INVENTION

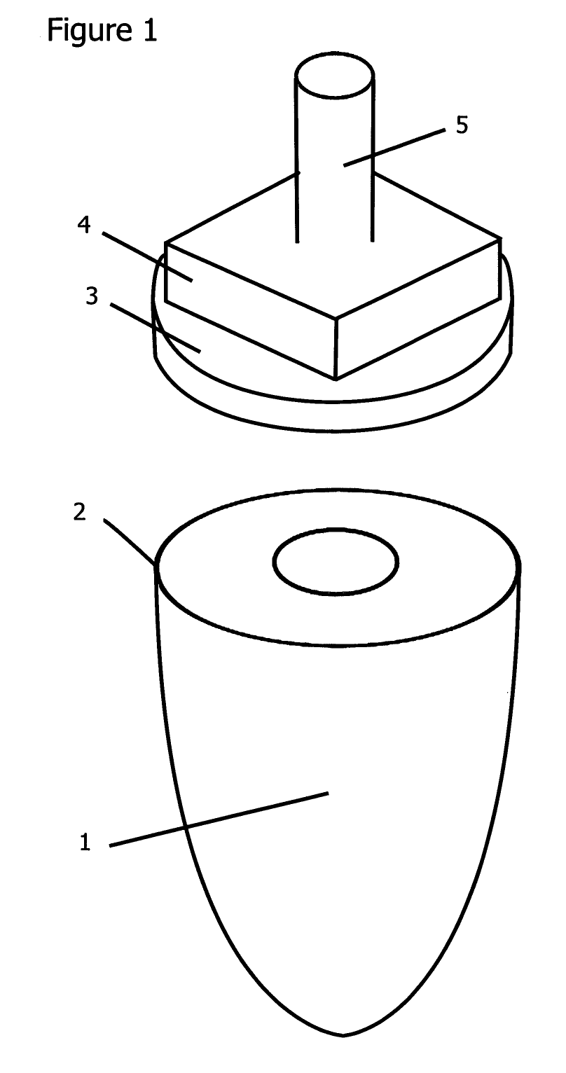

Before a tooth is atraumatically lifted from the socket, the dentist should cut a guideline into the tooth above the gumline to mark the position where the natural crown will be sheared away. Subsequently, as seen in FIG. 1, an extracted tooth (1) has been sheared off at the guideline mark to give a flat surface (2). A specially manufactured abutment (4) has a flat lower portion (3) for attachment and an upper stem (5) for grasping the abutment with the fingers.

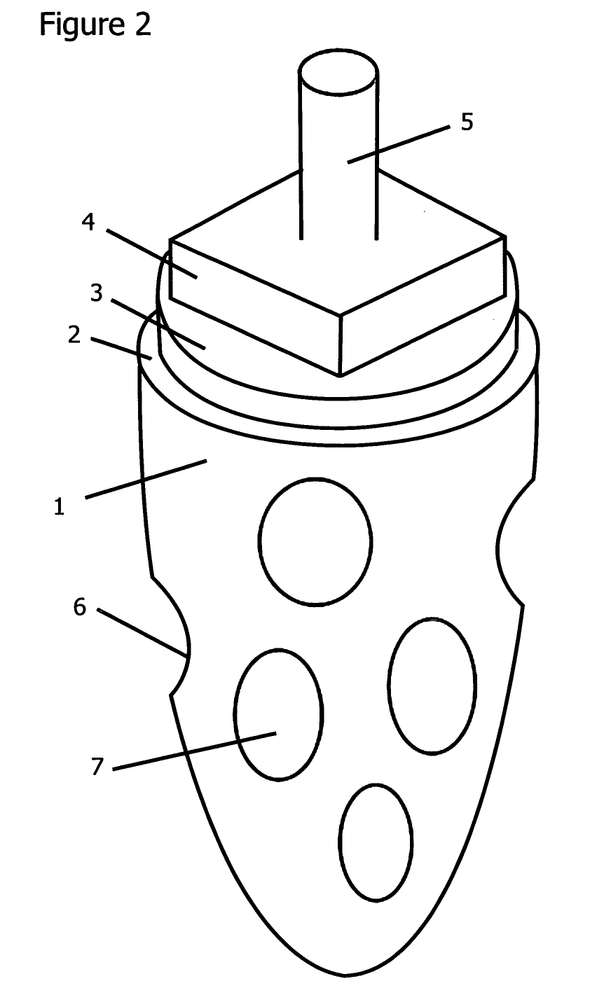

Next, as shown in FIG. 2, the abutment is glued by super adhesive to the tooth and the root surface is given a dozen or so small circular cavitations (6, 7) by a hand-held moto-tool or dental drill and a round tipped drill such as a #8 round bur (not shown). These bowl shaped surface alterations will later allow clumps of living cells to grow into the cavitations of the implant and harden naturally to secure it permanently.

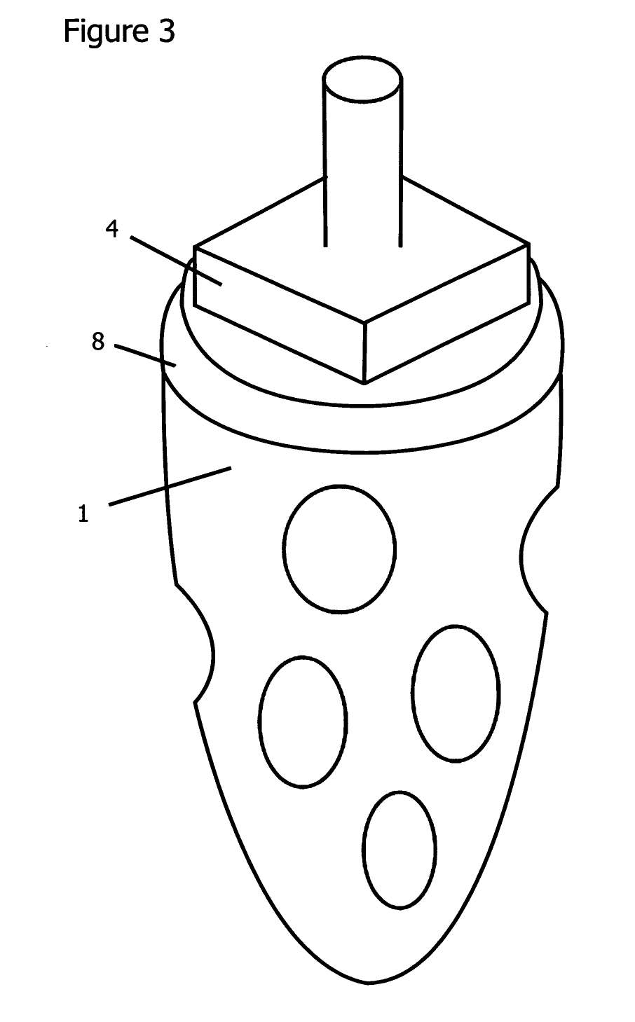

Next, as shown in FIG. 3, modeling clay (8) or other sculpture material is used to smoothly blend the edge of the larger diameter tooth (1) with the smaller abutment (4).

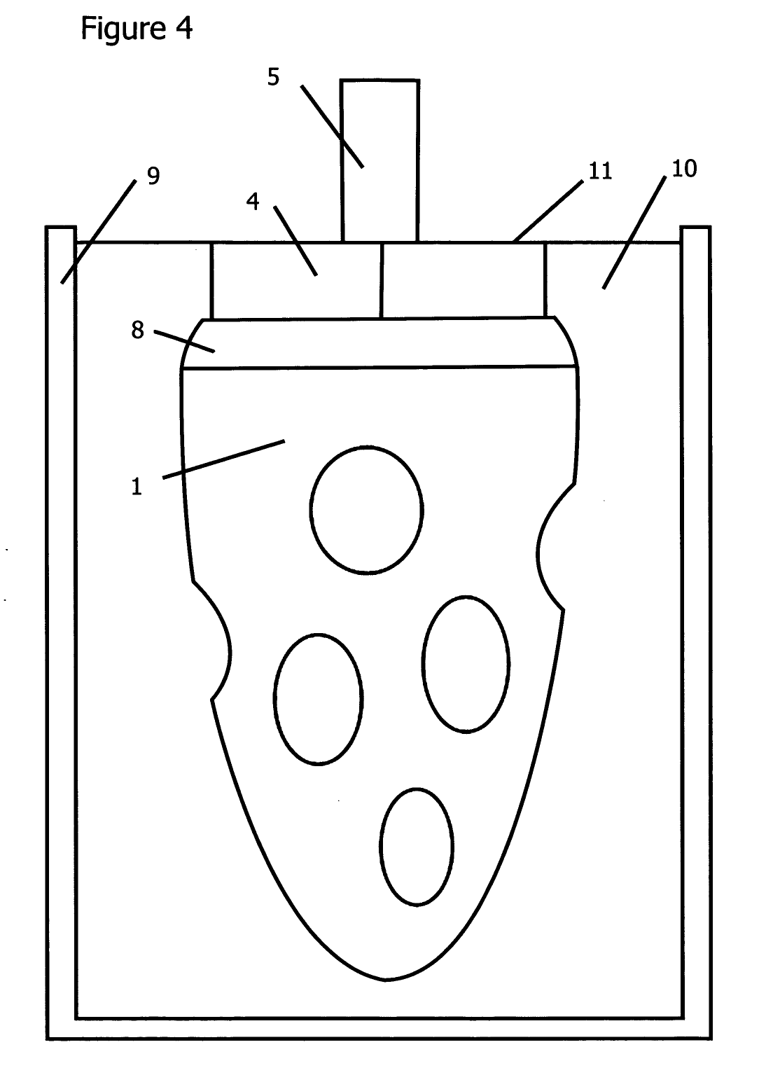

Next, the model is lifted by stem (5) and inserted into a containment cup (9) holding a still unsolidified mold rubber (10) as shown in FIG. 4. It is held thus for a few minutes while the water-clear and translucent rubber congeals. The mold hardens in 20 minutes or so. Because the rubber is pliable when cured, the model can be pulled upwards through opening (11) by grasping stem (5), which act is not shown.

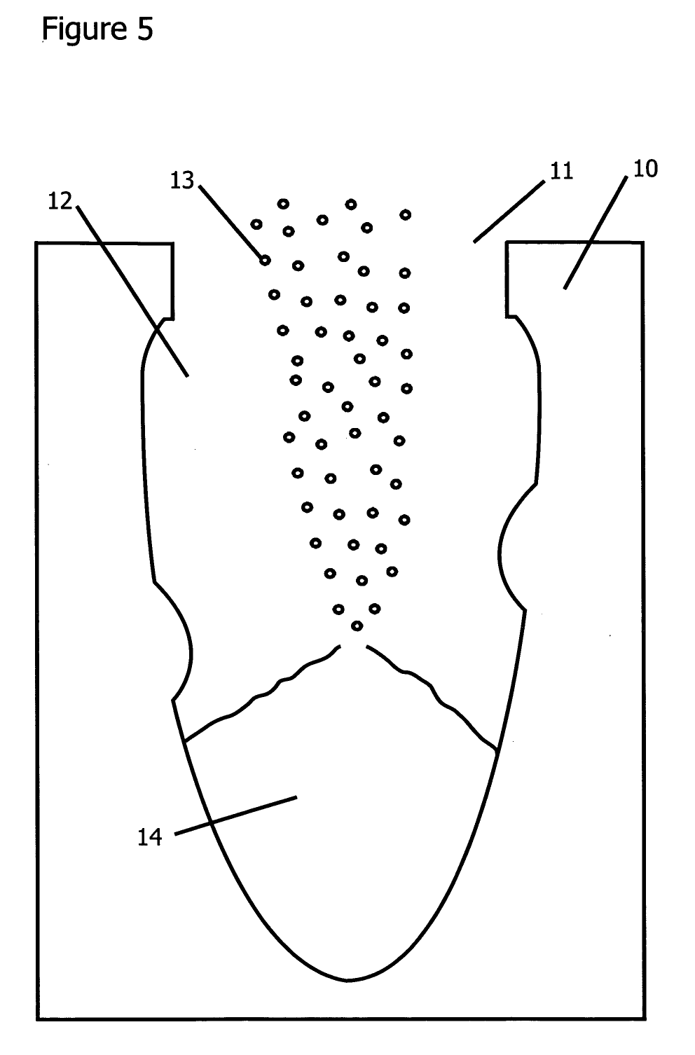

Next, as shown in FIG. 5, the empty space (12) inside mold rubber (10) is filled by pouring in tiny granules (13) of UHMWPE through opening (11) where they first collect in the lowest recess of the mold's cavitation as pure UHMWPE (14).

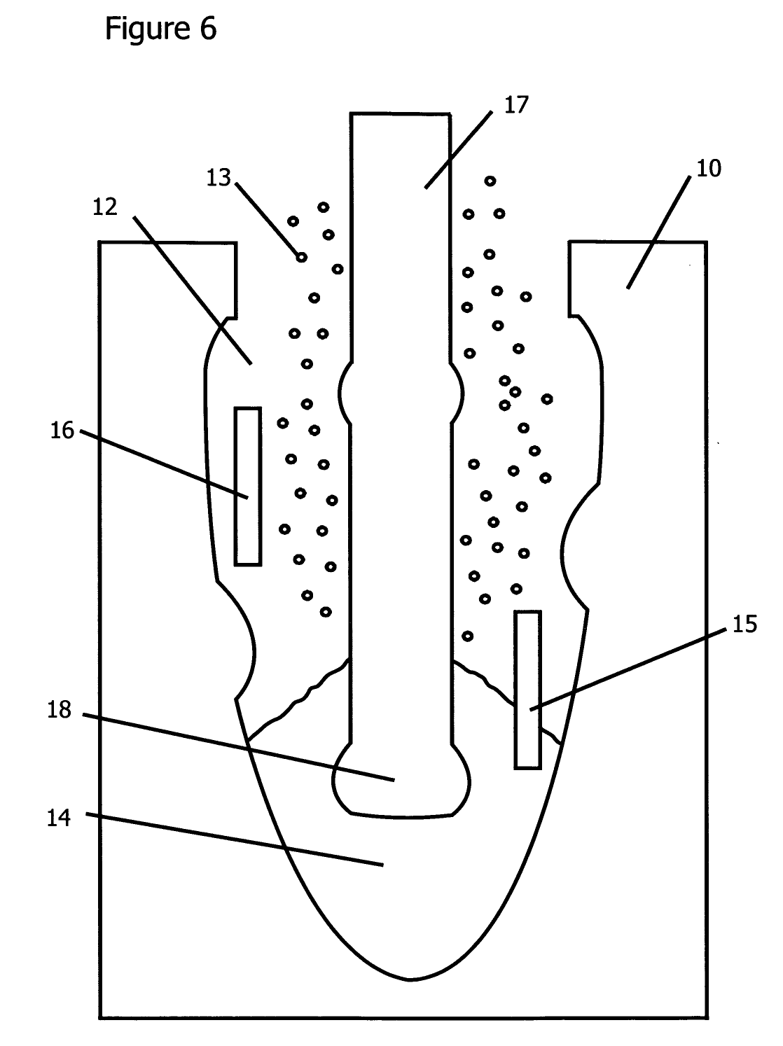

Alternately, before the mold is filled with granulated UHMWPE as shown in FIG. 6, thin strips of titanium (15, 16) are pressed against the inner cavity's wall and a stainless steel rod is lowered into the mold's empty space (12). This rod will later serve double duty as a stem handle (17) to pull the implant from the mold and as long term structural reinforcement to the implant. The rod has one or a plurality of size swellings (18) to insure motional fixation within the pure UHMWPE (14) as it is poured in.

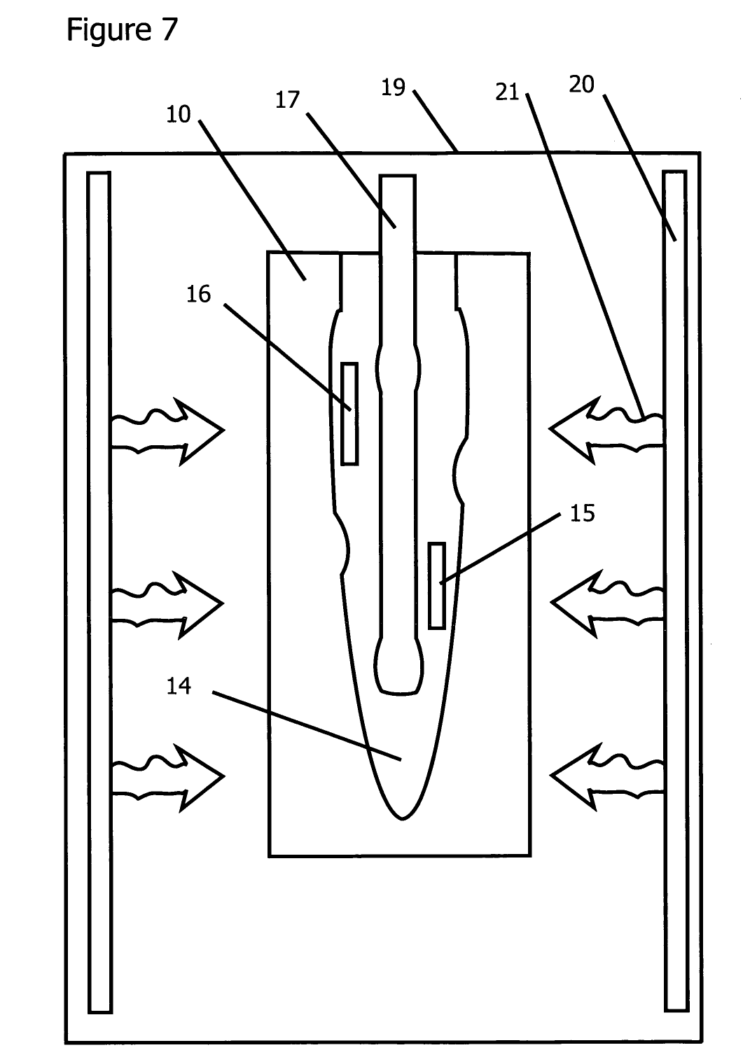

Next, as shown in FIG. 7, the filled mold is placed inside an irradiation box (19) having one or more emitters (20) that can release radiation energy (21) through the clear rubber (10) of the mold onto the crystals. This causes the crystals to melt and congeal together as the molecules of UHMWPE become highly cross-linked together. When cooled after the exothermic reaction, where interior temperatures typically do not exceed 60 degrees Celsius, the UHMWPE implant can be lifted out of the mold by the stem (17) for cleansing and sterilization before implantation back into the patient's mouth (not shown) after stem (17) is cut away from the top of the cloned abutment.

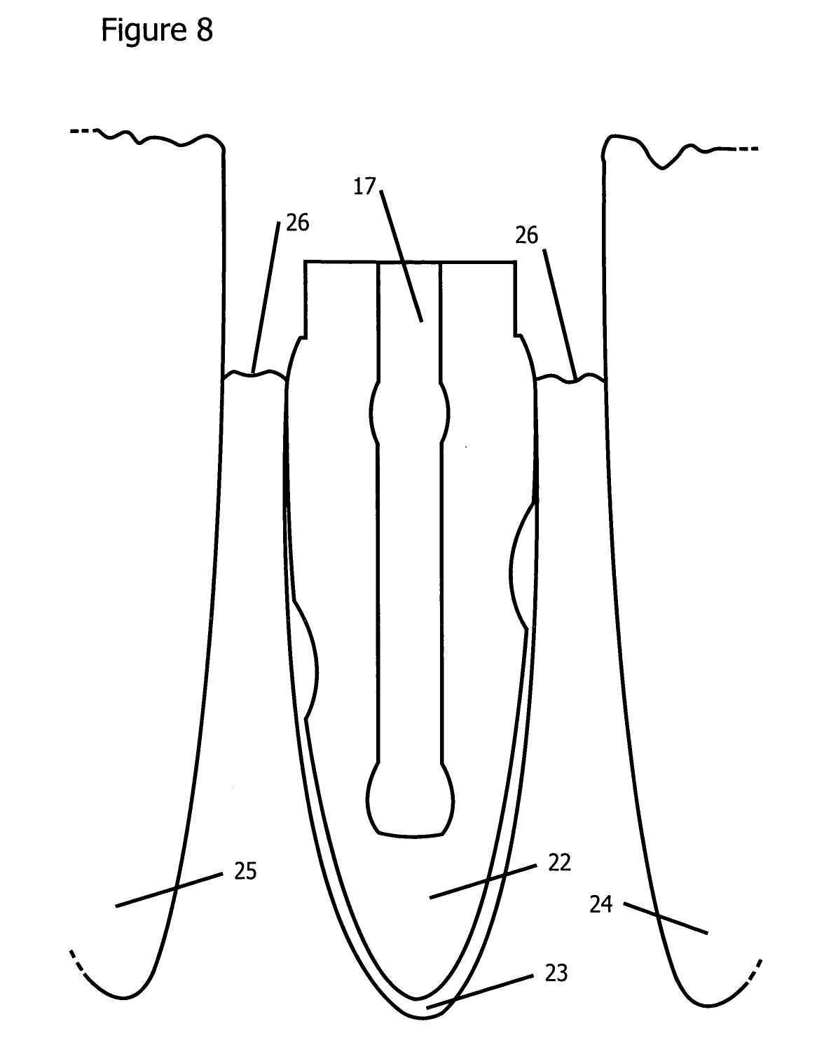

Next, as shown in the cutaway side view of FIG. 8, the UHMWPE implant (22) is inserted with the proper orientation back into the socket (23) of a patient from which the original tooth was removed some hours earlier. The socket is shown between the inner edges of two adjacent teeth (24, 25) separated from the implant by gumline (26).

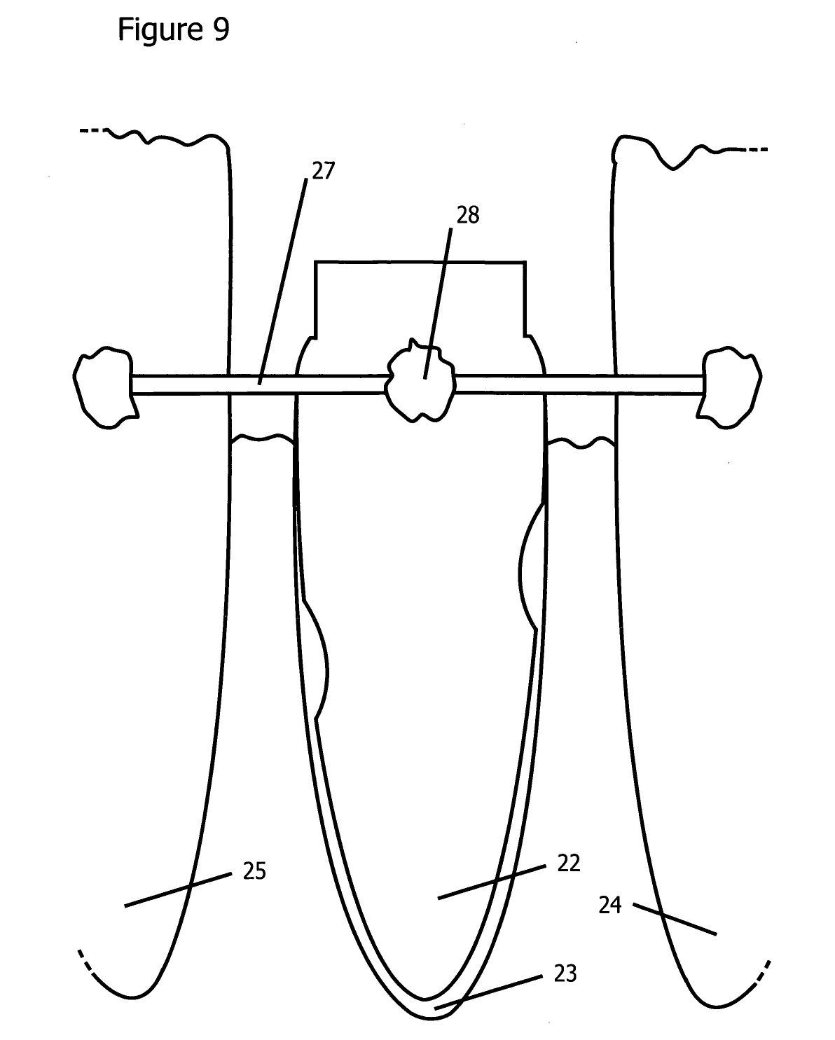

Finally, as shown in FIG. 9, the UHMWPE implant (22) is secured in place by orthodontic wire (27) adhered to the adjacent teeth by temporary dental surface adhesion resin (28), which can easily be removed at a later date.

Although the described excavations are intended as the preferred means for a natural attachment of the implant to the living tissues, alternately or in addition small strips of titanium can be adhered with a dab of adhesive wax to opposing sides of the rubber mold before it is filled with UHMWPE crystals. With these strips placed in positions chosen to not completely block the irradiation process, surface locations on the finished implant exist where traditional osseointegration can occur. This has the benefit of speeding up the recovery time before the capping process by several weeks.

The novel process enables the same day insertion of an implant sufficient to (some months later) support a porcelain cap as effectively as implants deriving from titanium or other competing systems. Because the UHMWPE implant follows the exact physical shape of the original tooth by a cloning process, the fit is assured. The instant invention both advances the current prosthetic dental art and better resolves the financial and medical needs of the patient.

The above procedures are presented as one way to attain the intended results for mammalian tooth replacement. There may arise or be alternate ways to clone a patient's tooth than the use of a transparent and flexible mold rubber as described in this paper as the preferred embodiment. There are alternate ways to secure the instant implant than with orthodontic wire. There may arise or be alternate chemical embodiments of UHMWPE or similar biocompatible chemical compositions than the one chosen in this paper for the preferred embodiment. The presence of these alternatives in the present or future art will not lessen the dominion of the instant invention. In other words, this invention should not be confined to the embodiments described, as many modifications are possible to one skilled in the art. This paper is intended to cover any variations, uses, or adaptations of the invention following the general principles as described and including such departures that come within common practice for this art and fall within the bounds of the claims appended herein.

I claim:

1. A method for replacing an extracted tooth from a mammalian jawbone with a biocompatible nonmetallic engineered implant of equal or less capacity than said tooth,
with a first step whereby the root of said extracted tooth is sheared of its original crown,
with a second step whereby a dental abutment is intimately contacted with the sheared surface of said tooth,
with a third step whereby said sheared tooth and said abutment are cloned to produce said engineered implant as a morphological alias of like dimensions with said sheared tooth and said abutment,
with a final step whereby said morphological alias is placed in the socket site of said jawbone losing said extracted tooth.

2. The method of claim 1,
with said first step of shearing off of said original crown of said extracted tooth producing a flat upper surface for said tooth,
with said abutment of said second step engineered with a flat lower surface matching the flat contacting topology of said extracted tooth after said shearing off of said original crown,
with the diameter of said flat lower surface of said abutment having a diameter less in all directions than the diameter of said sheared surface of said tooth.

3. The method of claim 1,
with said abutment of said second step engineered with an upper thin extension having a diameter less than that of said abutment, and extending up and away from said abutment for a length longer than the width of said abutment.

4. The method of claim 1,
with said intimate contact of said second step maintained by a thin layer of fast drying adhesive between said abutment and said tooth.

5. The method of claim 1,
with an additional step after said second step whereby the outer edge of said abutment and said tooth in said intimate contact are covered by a layer of modeling clay to create a smooth junction surface for said abutment and said tooth.

6. The method of claim 1,
with an additional step after said second step whereby the surface of said root is altered by the introduction of a plurality of shallow excavations removing portions of said surface of said root, whereby a large quantitative portion of said surface is not altered, and the altered portions provided are not in contact with each other.

7. The method of claim 6,
with said shallow excavations approximately circular at the surface of said tooth and bowl shaped below the surface of said tooth, whereby said bowl shape does not exceed 50 percent of a complete globe.

8. The method of claim 1,
with said third step having an initial stage where said abutment and said tooth are impressed together into uncongealed flexible molding rubber until said rubber congeals, whereby a cavity matching the outer dimensions of said abutment and said tooth is present within said congealed rubber after said abutment and said tooth are removed by vertical extraction from within said congealed molding rubber.

9. The method of claim 8,
with said third step having a further stage where said cavity is filled with small crystals of ultra high molecular weight polyethylene identified hereafter as UHMWPE,
with said third step having a further stage where said crystals are irradiated for a short duration with electron beam irradiation to induce congealing and cross linking of the molecules of said UHMWPE into said morphological alias derived from said abutment and said tooth, whereby said morphological alias is firm enough to be removed from within said cavity of said congealed rubber.

10. The method of claim 9,
with said morphological alias after said irradiation consisting of a solid chemical analogue identified as Highly Cross-linked UHMWPE.

11. The method of claim 9,
with said further stage of filling said cavity with said UHMWPE crystals predated by a step whereby one or a plurality of thin strips of titanium are placed flush with the inner contact surface of said cavity within said mold.

12. The method of claim 9,
with said cavity containing an upright rod having a lower portion sufficiently thin enough to not touch said congealed rubber and sufficiently thin enough to be completely surrounded by said crystals of UHMWPE, whereas said lower portion is within and part of said morphological alias formed by said irradiation.

13. The method of claim 12,
with said rod manufactured from stainless steel.

14. The method of claim 1,
with said morphological alias of said third step in said socket site of said jawbone secured to one or a plurality of surrounding teeth by dental bridging structure.

15. The method of claim 14,
where said dental bridging structure is orthodontic wire and surface adhesion resin.

16. A mammalian tooth socket dental implant that is a morphological alias relative to said tooth extracted from said socket,
with said implant formed of a biocompatible nonmetallic material,
with said implant having a plurality of surface excavations over the lower portion of said implant maintaining contact at its surface with living jawbone cells,
with the interior of said excavations smoothly scalloped such that the deepest portions are not at the border of said excavation,
with said implant having an upper portion not in contact with said jawbone cells engineered to the shape of a dental abutment.

17. A mammalian tooth socket dental implant as in 16,
with a centrally located rod running vertically through a majority of said upper portion of said implant and through a majority of said lower portion of said implant,
with said rod having one or a plurality of portions larger in diameter than the thinnest portions of said rod.

18. A mammalian tooth socket dental implant as in 17,
with said rod manufactured from stainless steel.

19. A mammalian tooth socket dental implant as in 16,
with said plurality of surface excavations replaced by one or a plurality of small pieces of titanium mounted flush with said contact surface of said implant and serving as part of said contact surface of said implant.

20. A mammalian tooth socket dental implant as in 16,
with said biocompatible material ultra high molecular weight polyethylene.
